(19) United States
(12) Patent Application Publication
(10) Pub. No.: US 2024/0002227 A1
(43) Pub. Date: Jan. 4, 2024

(54) PYROLYTIC EXTRACTION OF HYDROCHLORIC ACID FROM MAGNESIUM SALT MIXTURES, ESPECIALLY BITTERNS

(71) Applicant: LUNA INNOVATIONS INCORPORATED, Roanoke, VA (US)

(72) Inventors: Matthew MERRILL, Roanoke, VA (US); Greg SIMMS, Roanoke, VA (US)

(21) Appl. No.: 18/255,561

(22) PCT Filed: Nov. 3, 2021
(86) PCT No.: PCT/US2021/057821

§ 371 Date: Jun. 1, 2023

Related U.S. Application Data
(60) Provisional application No. 63/120,398, filed on Dec. 2, 2020.

(51) Int. Cl. C01B 7/07; C01D 3/08; C01F 5/30

(52) U.S. Cl. CPC C01B 7/0737; C01D 3/08; C01F 5/305

(57) ABSTRACT

Processes are provided which pyrolytically extract hydrochloric acid from a magnesium ion-rich salt mixture. In this regard, a supply of the magnesium ion-rich salt mixture (e.g., bittern) may be directed to a pyrolytic chamber where it is contacted with heated gas (e.g., combustion flue gas) at a sufficient temperature and for a sufficient time to form a vapor product stream comprised of hydrochloric acid and an insoluble pyrolyzed mixed salt stream comprised of magnesium hydroxide and sodium sulfate decahydrate. The solid pyrolyzed mixed salt stream may be separated into separate product streams comprising the insoluble magnesium hydroxide and remaining soluble salt fractions, while the vapor product stream of hydrochloric acid from the pyrolytic chamber may be condensed form an aqueous HCl solution. The magnesium ion rich salt mixture may be dehydrated prior to pyrolysis to achieve magnesium ions in a tetrahydrate state or lower (e.g., a monohydrate to a trihydrate state).

### RELATED APPLICATIONS

This application is based on and claims priority benefits from U.S. Provisional Application Ser. No. 63/120,398 filed on Dec. 2, 2020, the entire contents of which are expressly incorporated hereinto by reference.

### GOVERNMENT RIGHTS

This invention was made with Government support under the following Government awarded contract: Department of Energy, Office of Science, Office of Basic Energy Sciences under Award Number DE-SC0017142. The Government has certain rights to the invention.

### FIELD

The present invention relates generally to processes for extracting hydrochloric (HCl) acid from salt and salt mixtures. Certain embodiments of the invention relate to HCl extraction processes based on the pyrolysis (pyrohydrolysis) of hydrated magnesium chloride (MgCl₂) and Mg-rich salt mixtures according to the following reaction scheme (Reaction 1):

MgCl₂+2H₂O+heat→Mg(OH)₂+HCl (Reaction 1)

Certain other embodiments disclosed herein relate more specifically relate to pyrolytic HCl extraction processes from bitterns, brines, and other mixed salts that may be separated into commercially attractive minerals.

### BACKGROUND AND SUMMARY

A common approach to sodium chloride (NaCl) salt production is the solar evaporation of seawater or similar saltwater resources, which results in a mixed salt byproduct known as bittern.¹ While bittern is a potential mineral resource that is rich in sodium, potassium, magnesium, chloride, and sulfate, it is presently unused because there are often no cost-effective approaches to separating this salt mixture into commercially salable products. While many bittern processing approaches have been proposed, they are typically not cost-effective because they require the consumption of prohibitively expensive minerals and produce relatively low value products. These unused bitterns may either be stockpiled or released back into the ocean or other body of water.

What has therefore been needed in this art are processes that are better able to extract commercially salable chemicals or minerals from sodium and magnesium chloride-based salt systems with less cost, less energy, and less greenhouse gas emissions. The embodiments as disclosed herein is directed to fulfilling such need.

In this regard, the processes according to the embodiments disclosed herein are directed toward a novel approach to apply relatively inexpensive heat to salt systems to thereby efficiently extract and collect HCl from mixed salt systems. This innovative HCl-extraction process based on magnesium chloride pyrolysis was initially developed to enable the profitable processing of bitterns and other mixed or magnesium-rich salts into commercially salable products. The embodiments described herein however instead employs a relatively inexpensively small amount of heat to release HCl and separate the magnesium through precipitation as magnesium hydroxide Mg(OH)₂ and related insoluble magnesium-based products from soluble sodium, potassium, chloride, and sulfate salts according to the following representative reaction (Reaction 2):

MgSO₄·(NaCl)₃·KCl(H₂O)₂→2HCl+Na₂SO₄+NaCl+KCl+Mg(OH)₂ (Reaction 2)

The sulfate obtained by such processing can then be removed as sodium sulfate (Na₂SO₄) through a Glauber's salt precipitation to thereby liberate additional NaCl. The Mg(OH)₂ byproduct can then optionally be processed for sale as purified Mg(OH)2 or MgO, recycled back to MgCl2 for reintroduction back into the mixed salt brine, or fed to a collection pond for direct air capture of CO₂ through conversion to MgCO₃. The NaCl product of the embodiments disclosed herein will be enriched in potassium chloride (KCl) and enables opportunities for potash production.

These and other aspects and advantages will become more apparent after careful consideration is given to the following detailed description of the preferred exemplary embodiments thereof.

### BRIEF DESCRIPTION OF THE DRAWINGS

Reference will hereinafter be made to the drawing Figures, wherein:

FIG. 1 is a simplified block flow diagram depicting an embodiment in accordance with the invention disclosed herein;

FIG. 2 is a further schematic process flow diagram of an embodiment in accordance with the invention disclosed herein;

FIG. 3 is a graph showing HCl yield as a function of temperature and time for a sample of bittern pyrolyzed with a hot flue gas;

FIG. 4 is a graph showing the HCl yield as a function of natural flue gas combustion stoichiometry and time for a sample of bittern undergoing pyrolysis;

FIG. 5 is a graph showing the HCl yield as a function of magnesium ion hydration state samples of bittern pyrolyzed with a hot flue gas;

FIG. 6 is a graph showing simulated and experimental results for Glauber's salt precipitation as a function of temperature with the dotted line being the simulation extrapolation;

FIGS. 7-10 are process flow diagrams of a process in accordance with an embodiment of the invention described herein; and

FIGS. 11A-11D are mass flow charts of a representative 1 MM tonne MS per year processing facility employing the process as shown in FIGS. 7-10.

### DETAILED DESCRIPTION

As noted briefly above, the embodiments as disclosed herein have a strong potential to enable the profitable conversion of bitterns into salable products. While bitterns specifically refer to the mixed salt byproduct of salt produced through the solar evaporation of seawater, the embodiments disclosed herein can be applied to any salt, salt brine, or mixed salt (primarily sodium, chloride, potassium, sulfate, bromine, calcium, lithium, carbonate) system that already includes significant fractions of magnesium or to which magnesium can be added.

The overall functions of the process embodiments described herein are to enable profitable processing of mixed salt systems such as bitterns and brines into higher value chemicals and minerals and enhance the productivity of mineral manufacturing. The processing approach of the embodiments described herein uniquely avoids the use of chemical consumables and is instead based on the extraction of hydrochloric acid (HCl) from bitterns or other mixed salt systems through hydrochloric acid extraction technology.

The value of the extracted HCl governs the overall profitability of the herein described processes. The hydrochloric acid is extracted through the pyrolysis of the magnesium chloride fraction that is a natural component of bittern. This pyrolysis step applies a relatively inexpensive amount of heat to release HCl and separate the magnesium through precipitation as magnesium hydroxide Mg(OH)₂. The sulfate is then removed as sodium sulfate (Na₂SO₄) through a Glauber's salt precipitation to liberate additional NaCl.

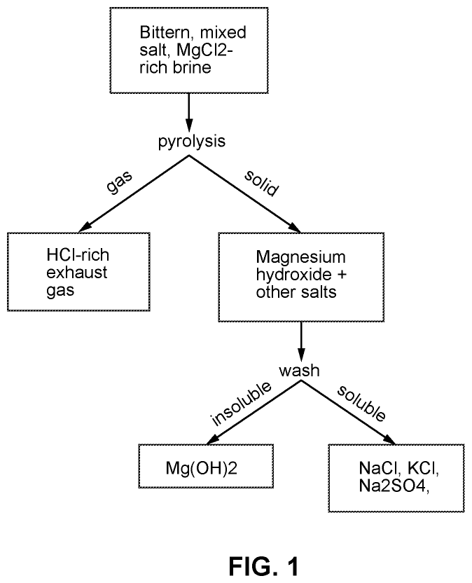

Accompanying FIG. 1 is a simplified block flow diagram depicting an embodiment in accordance with the invention disclosed herein. As shown, a supply of bitterns, brines and other mixed salts are subjected to pyrolysis to obtain a HCl-rich exhaust gas stream and a solid stream comprised of magnesium hydroxide and other salts. A subsequent wash of the solid stream will thereby yield insoluble magnesium salt (Mg(OH)₂) and soluble salts such as sodium chloride, potassium chloride and/or sodium sulfate.

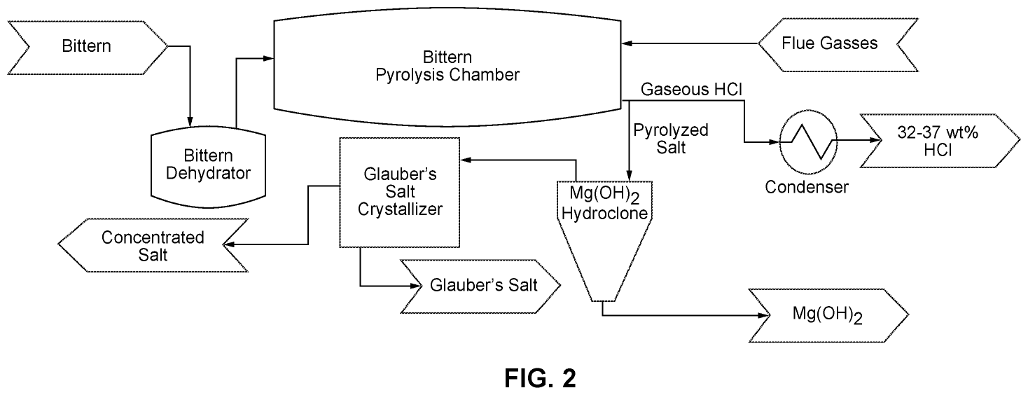

FIG. 2 further schematically depicts an abbreviated process flow diagram of the HCl extraction process in accordance with an embodiment of the present invention. In this regard, bittern is supplied to a bittern dehydrator and then subsequently to a pyrolysis chamber where a pyrolysis step removes about 85 mol % of the potential HCl. A subsequent wash step removes about 85 mol % of the magnesium as insoluble Mg(OH₂) which may be directed to a Glauber's salt crystallizer where a Glauber's salt precipitation step removes about 95 mol % of the sulfate as Na₂SO₄·(H₂)₁₀. The remaining concentrated NaCl solution discharged from the Glauber's salt crystallizer may be further processed so as to extract potassium chloride (KCl) and then recycled to solar evaporation ponds to increase salt production capacity. The Mg(OH)₂ separated from the pyrolyzed salt discharged from the bittern pyrolysis chamber and can be processed into a purified Mg(OH)₂ or MgO product or directed to an open-air holding site where it will spontaneously absorb CO₂ from ambient air and may therefore be repurposed for carbon sequestration. Alternatively, the Mg(OH) can be recycled back to MgCl₂ using the ammonium chloride (NH₄Cl) generated through soda ash production (sodium carbonate; Na₂CO₃) through the following reaction (Reaction 3):

Mg(OH)₂+2NH₄Cl→MgCl₂+2NH₃+2H₂O (Reaction 3)

Soda ash can be produced through Reaction 4 by combining the pyrolysis of Reaction 1 with the separation of Na₂CO₃ through Reaction 5 and the recycling of MgCl₂ and NH₃ by Reaction 3.

2NaCl+H₂O+CO₂→Na₂CO₃+2HCl (Reaction 4)

2NaCl+2NH₃+CO₂+H₂O→Na₂CO₃+2NH₄Cl (Reaction 5)

The embodiments as described hereinbelow are based principally on a pyrolysis step and a Glauber's salt (sodium sulfate decahydrate (Na₂SO₄·(H₂O)₁₀) also known as mirabilite) precipitation step.⁸ The principal processing goals of the pyrolysis step are to extract HCl and remove magnesium as an insoluble mineral. The principal processing goal of the Glauber's salt precipitation step is to remove a high yield of sulfate in a highly selective separation step. While process options can be applied if the mixed salt feed has a significantly different composition, the discussion which follows assumes a bittern feed composition representative of the global salt industry for the solar evaporation of seawater represented in Table 1 below.⁹

TABLE 1
Bittern compositions (mol %).⁹

| | Reported | Alternate* |
|---|---|---|
| NaCl | 67.3 | 53.1 |
| Na₂SO₄ | 0.0 | 10.7 |
| MgSO₄ | 9.7 | 0.0 |
| MgCl₂ | 17.8 | 30.4 |
| KCl | 5.2 | 5.7 |

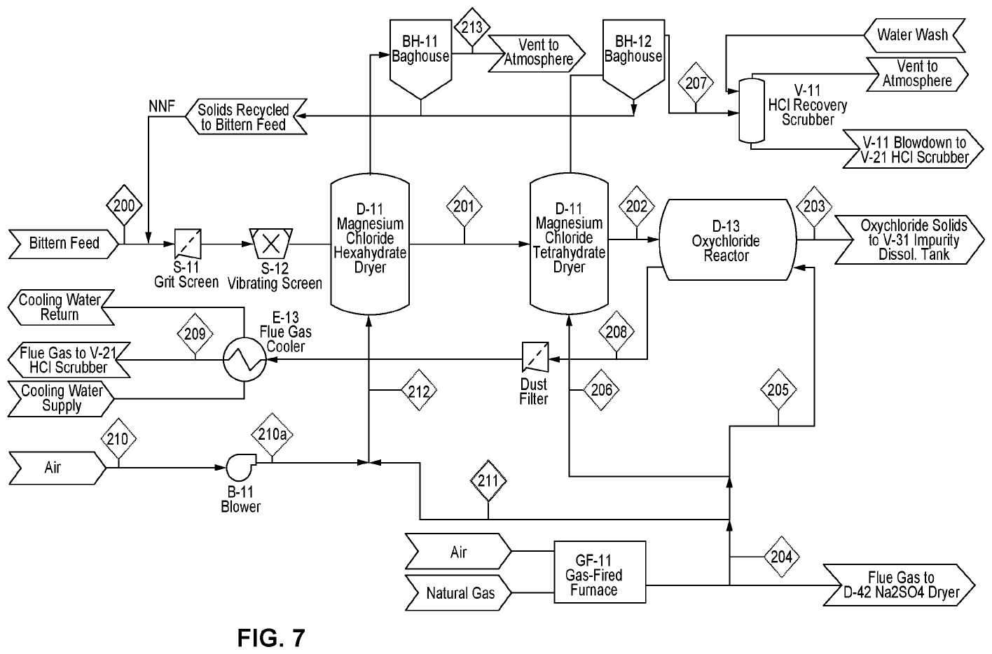

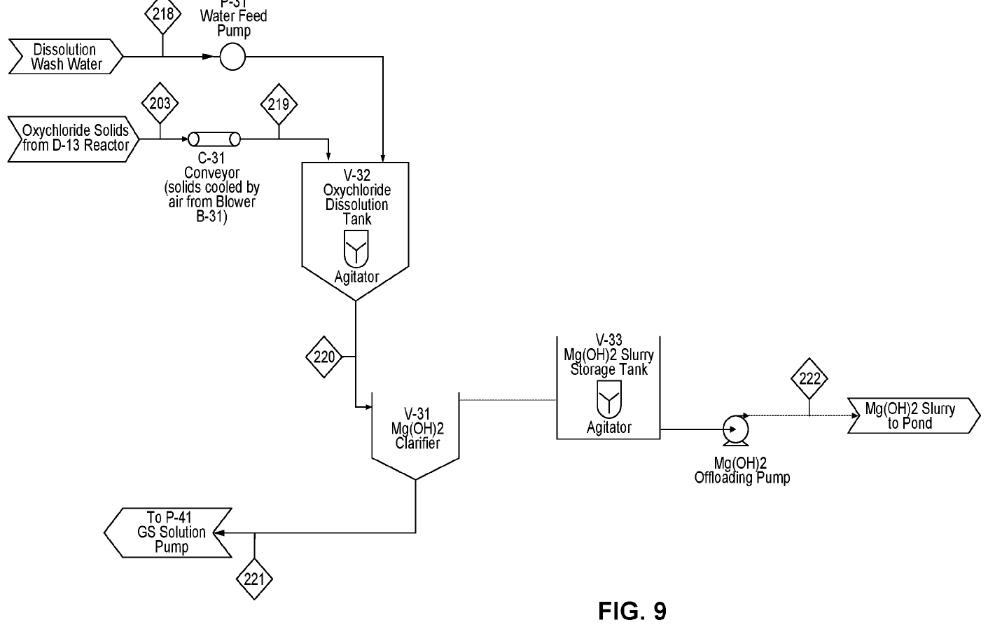

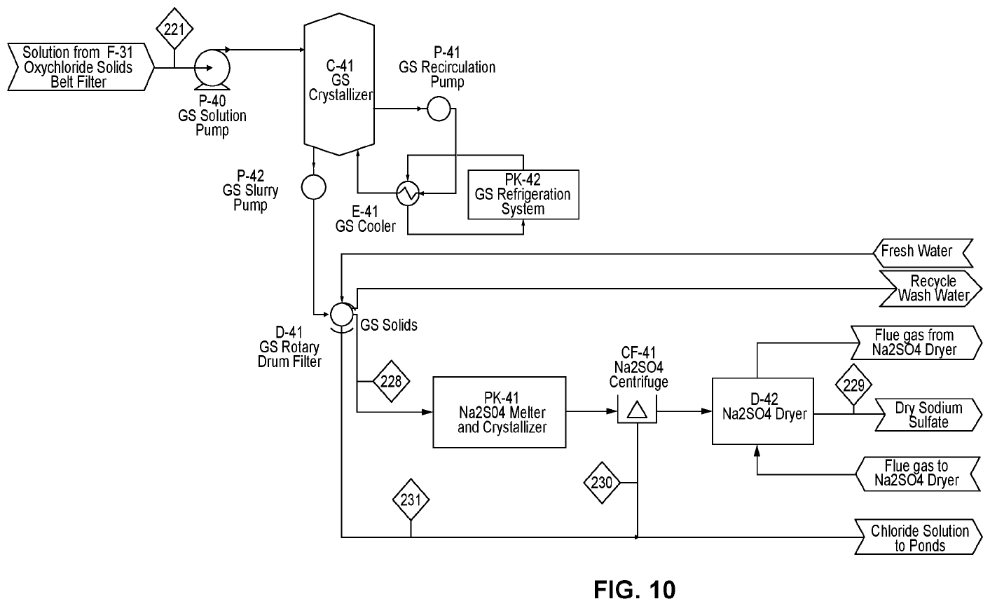

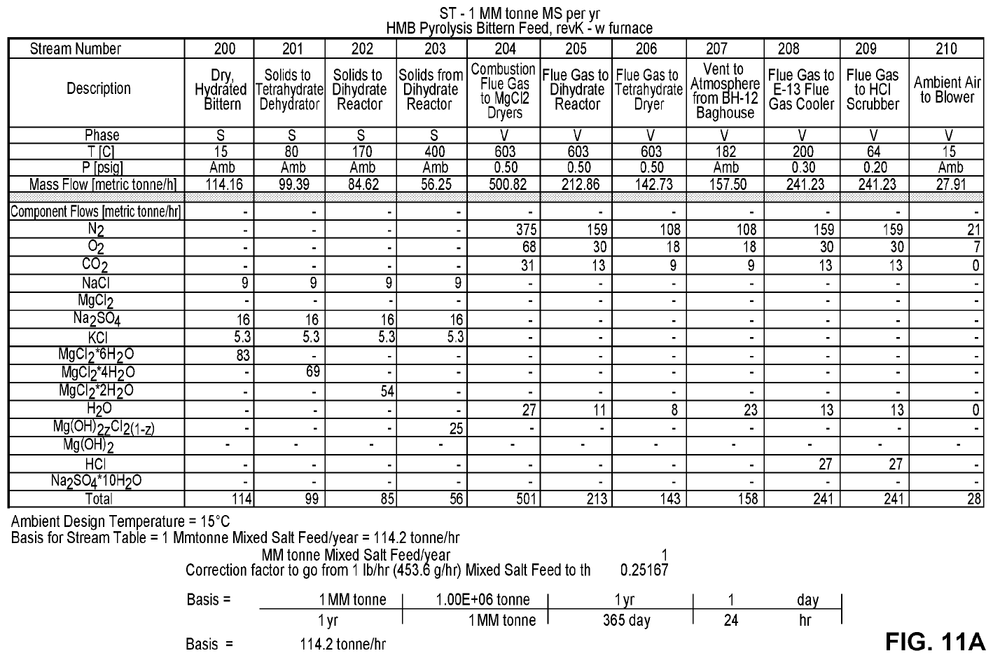

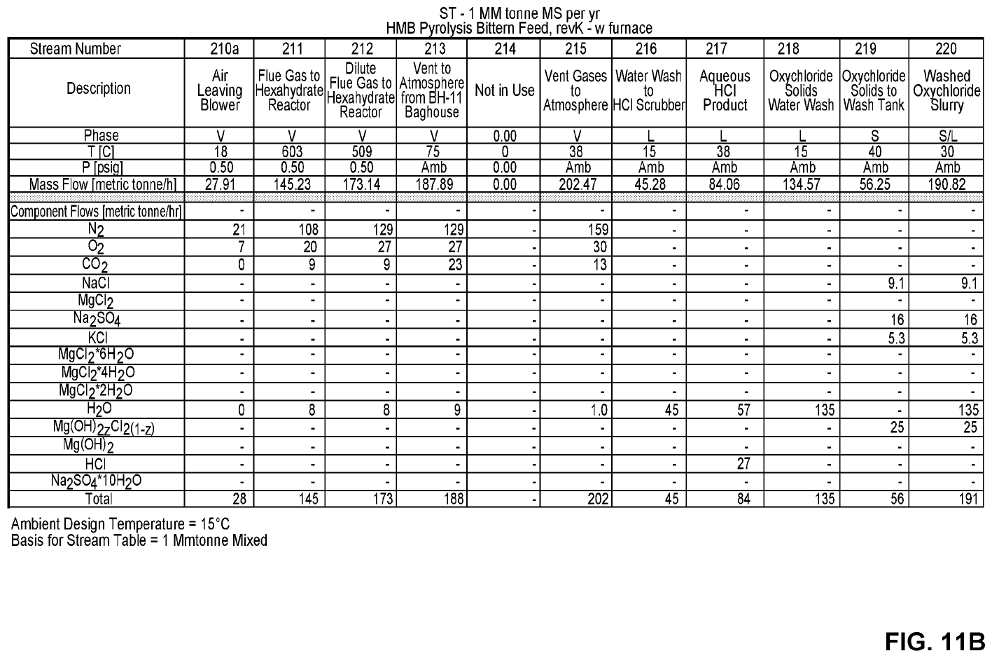

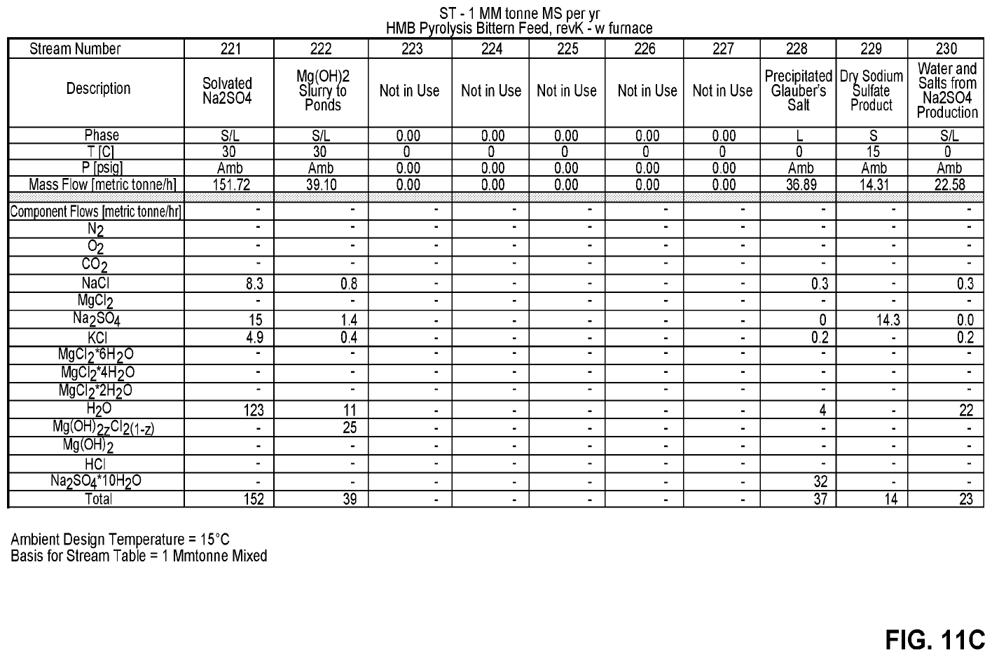

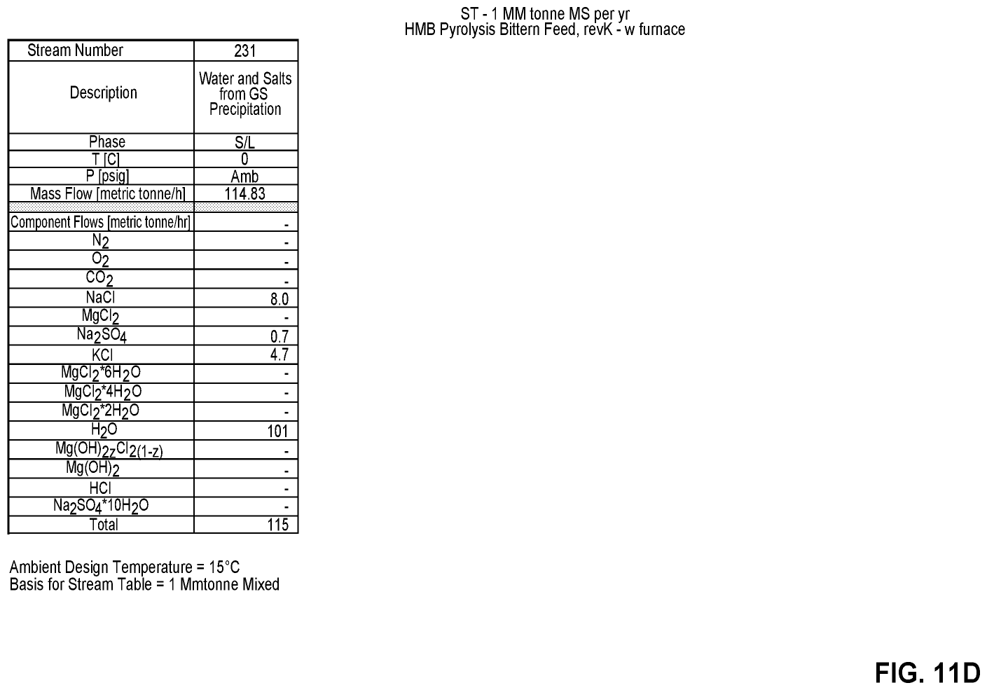

For a conventional bittern mixed salt composition, the most effective option is to pyrolyze the mixed salt and then separate the Glauber's salt as shown schematically in FIG. 2. The heat and mass balance of the overall process has been accounted for a 1 million tonne of bittern per year process rate. See in this regard the mass balance charts of FIGS. 11A-11D based on the process flow diagrams of FIGS. 7-10. Variations of the same fundamental process can be applied if the mixed salt composition differs significantly from the conventional composition of bittern. For example, if a mixed salt composition contains a relatively lower ratio of MgCl₂ to Na₂SO₄, the Glauber's salt can be precipitated prior to the pyrolytic HCl extraction step for overall greater process performance. Any combination or sequence of concentration-based, pH-based, or temperature-based separation steps can be used in combination with the pyrolytic HCl extraction step to enable the separation of commercially salable minerals from salt brines and mixed salt systems.

### 1.1 Bittern Preparation

The bittern is conventionally discarded from the solar evaporation process as a concentrated solution of mixed salts that is only 71 wt % water.⁹ The embodiments as disclosed herein will typically consume the bittern feed which is dried to hydrated salt granules with typically 25 wt. % to about 35 wt. % water (preferably about 27wt. % to about 30 wt. % water, and more preferably about 29 wt. % water), based on the total weight of the bittern, which is generally consistent with the magnesium ions remaining in the hexahydrate state. The magnesium ions are highly hygroscopic and typically bind six water molecules to exist in the hexahydrate state in typical ambient conditions. The bittern may have already been pre-dried during a bittern stockpiling process or new bittern may be dried through a combination of solar evaporation and the application of low-grade heat byproduct integrated from the process.

Since the water vapor content of flue gas also contributes water to the hydrochloric acid product during the pyrolysis process, the water hydrating the magnesium ions in excess of the dihydrate state needs to be removed to achieve a high-value, e.g., about 30 wt. % to about 37 wt. %, of the HCl product concentration in water. The mixed salt is most preferably dried using a combination of direct contact with hot flue gas generated by natural gas combustion and indirectly through heat exchanged from the hot exhaust gas, HCl gases produced in the pyrolysis step, and/or heated ambient air. Magnesium chloride hexahydrate loses four water molecules to reach the dihydrate state around 110-150° C., which has been confirmed with experimental gravimetric measurements.¹¹⁻¹³ The water molecules that hydrate magnesium ions may require increasingly higher energy to remove and therefore, in certain applications, two specific drying steps dry the magnesium ions to the tetrahydrate state and then to the dihydrate state may be preferable.¹⁰

### 1.2 Pyrolysis

A principal goal of the pyrolysis processing step is to produce HCl through the pyrohydrolysis of magnesium ions in the chloride-rich bittern by the application of heat. The pyrolysis step will cost effectively produce a high value, e.g., 20-45 wt %, and preferably between about 30 to about 37 wt %, solution of HCl in water and enables magnesium removal from the remaining mixed salt. This HCl solution (typically 20-22° Baume) is a standard composition that correlates to about 1 molecule of HCl per 4 molecules of water (H₂O). More diluted solutions, such as 18-22 wt % HCl, while possible will have a significantly lower value that will decrease the profitability of the overall process.

The mixed salt may be pyrolyzed through direct contact with the flue gas generated through the combustion of natural gas, which contributes water vapor to the aqueous HCl product. Preferably, the hot flue gas will directly contact the mixed salt in a counter-current flow configuration within a rotary kiln. Alternatively, the mixed salt may be pyrolyzed indirectly, e.g., by use of a heat exchanger. The direct contact of the mixed salt by the flue gas and associated pre-dry step is likely to be preferred as it has been found to be easier and less expensive than an indirect approach to the heating of the mixed salt by use of a heat exchanger.

The two bound water molecules that strongly hydrate magnesium ions hydrolyze magnesium chloride at elevated temperatures to produce HCl and a mixture of magnesium hydroxychloride and magnesium hydroxide products through Reactions (1) above and the following Reactions (6)-(8):¹¹⁻¹³

MgCl₂+H₂O↔Mg(OH)Cl+HCl Reaction (6)

2MgCl₂+3H₂O↔Mg₂(OH)₃Cl+3HCl Reaction (7)

Mg(OH)Cl+H₂O↔Mg(OH)₂+HCl Reaction (8)

Most of the HCl can be extracted with relatively low temperatures (300-900° C.) and processing times (5-80 minutes). The HCl is preferably extracted at 450-550° C. and 10-40 minutes to enable high concentrations of HCl product collected from the gas phase of the pyrolysis process. The flue gas flow rate and composition are also controlled to enable high concentrations of HCl product. The flue gas (2-6 vol % CO₂, 4-12 vol % H₂O) from the lean combustion of natural gas (methane) is preferable. The flue gas (6-11 vol % CO₂, 12-22% H₂O) of rich combustion of natural gas or the flue gas of other hydrocarbon or fossil fuels can also be applied for pyrolysis.

The mixed salt undergoing pyrolysis is typically dried as noted previously so that the magnesium is in at least the tetrahydrate state or lower (≤4 H₂O bound to magnesium ions), and preferably in the monohydrate to trihydrate state (1-3 H₂O bound to magnesium ions). After HCl extraction, the remaining magnesium hydroxychloride and hydroxide byproducts are highly insoluble and can be separated from the remaining sodium, potassium, chloride, and sulfate ions with a wash step.

### 1.3 Magnesium Hydroxychloride Separation

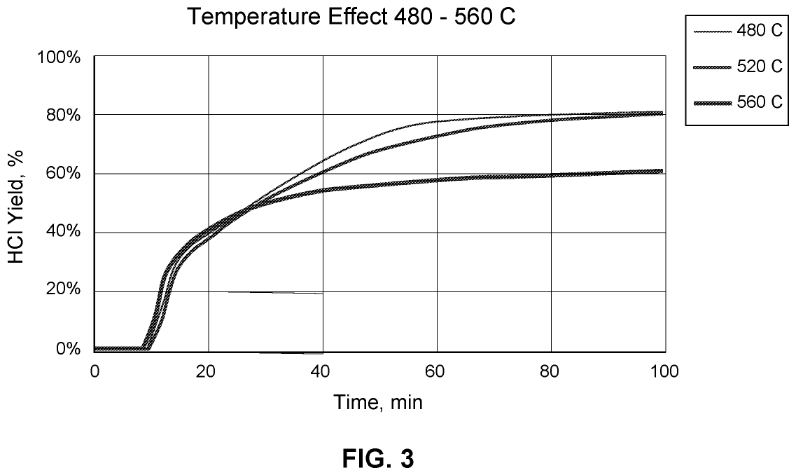

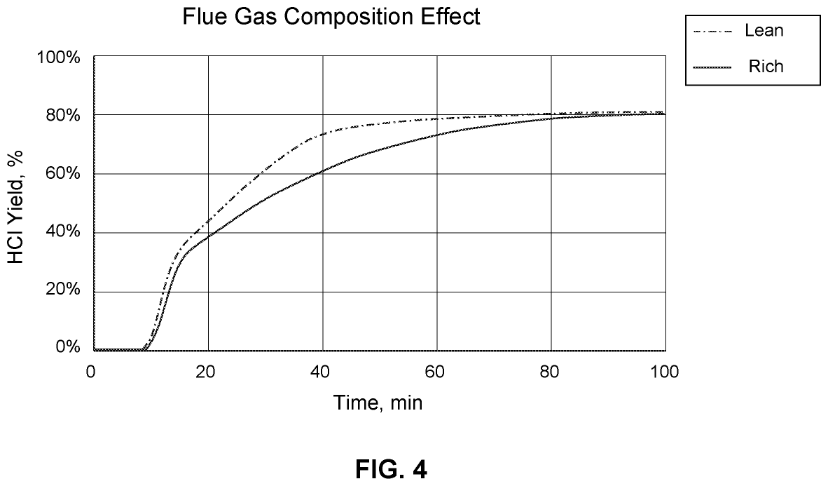

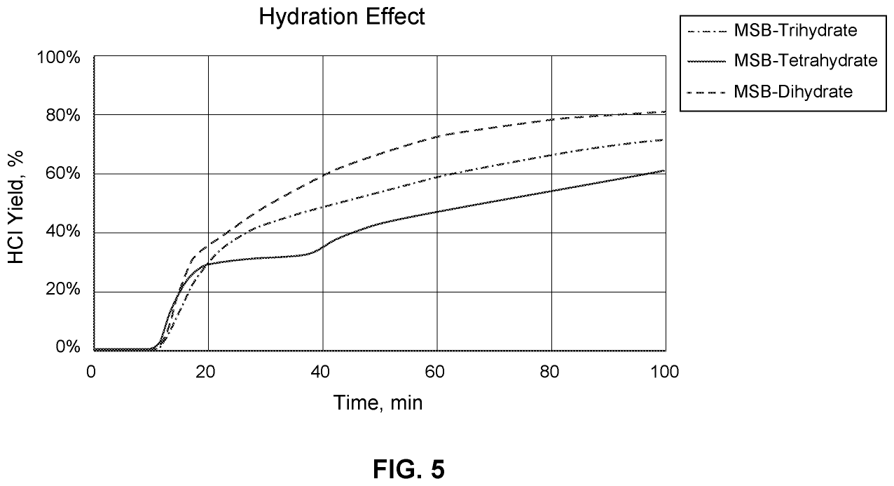

The pyrolyzed, solid mixed salt system is washed to separate the soluble material from the insoluble material. Experimental measurements confirm that >80 mol % of the highly insoluble magnesium hydroxychloride and hydroxide components are removed from the mixed salt system through the combination of pyrolysis and subsequent wash step in accordance with the extent of hydrolysis expected from HCl yields (see FIGS. 3-5).¹⁴ The wash will typically remove 90-mol % of the soluble (sodium, potassium, chloride, sulfur) ions from the insoluble, hydrolyzed magnesium compounds.

The insoluble, hydrolyzed magnesium phase is a fine powder when dried. The insoluble phase may be further purified to provide magnesia. Thermodynamics indicate that highly alkaline, insoluble magnesium will spontaneously absorb CO₂ to form magnesium carbonate (MgCO₃) minerals. Minerals that contain alkaline magnesium are the most effective for CO₂ sequestration.¹⁵ Bitterns and other mixed salts may be the most concentrated and easily assessable source of magnesium for mineral carbonation. If used to line the beds of the solar evaporation ponds, thermodynamics indicate the insoluble, hydrolyzed magnesium phase will form dolomite (CaMg(CO₃)₂) due to the availability of calcium ions. The process according to the embodiments described herein will achieve a >90% reduction in remaining mineral volume with respect to the initial mixed salt used as the process feed source.

### 1.4 Glauber's Salt Precipitation

A Glauber's salt precipitation removes sulfate as sodium sulfate decahydrate (Na₂SO₄·(H₂O)₁₀) after the hydroxychloride wash step. The solubility of the decahydrate state of sodium sulfate is highly temperature dependent and can be separated with high yield and selectivity at low temperatures.⁸ The mixed salt is resuspended in fresh seawater during the oxychloride wash steps to perform the subsequent precipitation. The precipitation achieves relatively high yields (>90 mol %) of Glauber's salt at about 0° C. (+/−about 5° C.). The yield of Glauber's salt is similar to expectations based on aqueous chemical equilibrium model simulations. The precipitated Glauber's salt is filtered, washed, and then dried at 150° C. to produce a purified, anhydrous sodium sulfate product.

The wash followed by this Glauber's salt precipitation step produces a concentrated, salt-rich 60 mol % NaCl+35 mol % KCl) solution that can be cycled back to the solar evaporation ponds to harvest additional salt or to facilitate the removal of KCl to produce potash. The NaCl and KCl concentrations are the solubility limits in this salt-rich solution, which corresponds to NaCl concentrations over eight times greater than that of seawater. If the rate of water evaporation is rate-limiting during the solar evaporation process, then about 90 mol % of the NaCl and KCl can be harvested from this system using ⅛^{th} of the time and evaporation pond area in comparison with fresh oceanwater. This fast, space-efficient NaCl/KCl production stream can increase revenue generation by increasing the total salt production capacity of the solar evaporation facility.

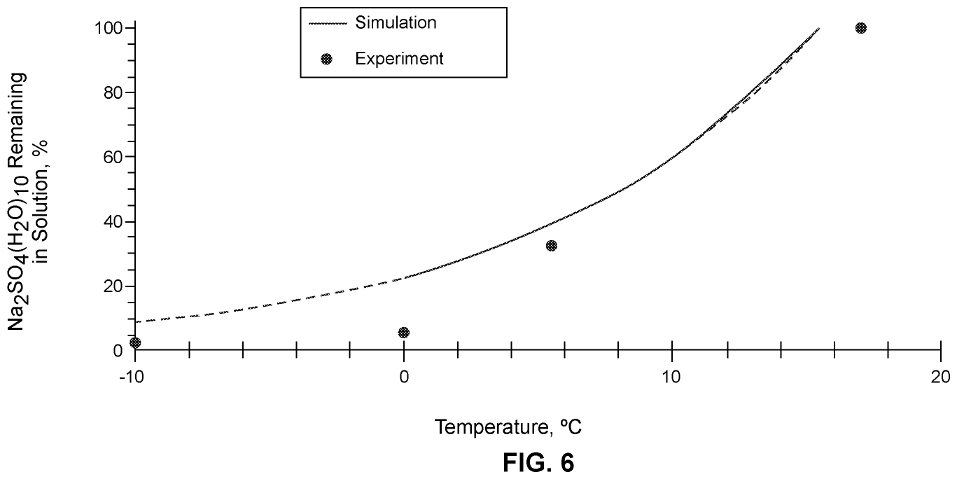

Accompanying FIG. 6 is graph showing simulated and experimental results for Glauber's salt precipitation as a function of temperature with the dotted line being the simulation extrapolation.

### 1.5 Flue Gas Generation

The heat for the pyrolysis step is produced from the combustion of inexpensive natural gas, although flue gases from the combustion of other hydrocarbons or fossil fuels can also be employed. According to certain embodiments, a gas-fired furnace may be integrated to provide energy for drying the MgCl₂ in the bittern feed to the dihydrate state and to pyrolyze the dried bittern. The hot flue gas exits the furnace and is then brought into directly contact with the mixed salt containing magnesium in the dihydrate state for pyrolysis in a counter current exchange process within the bittern pyrolysis chamber which may be embodied in the form of a rotary kiln. The gas furnace also dries the Glauber's salt (sodium sulfate decahydrate) to the anhydrous product state suitable for shipment. See in this regard accompanying FIG. 7.

An additional process option exists in which the gas-fired furnace could be replaced by a 22-MW gas turbine (not shown) for combined heat and power generation. The electricity generated by the gas turbine could then be used to power the electric refrigeration of the Glauber's salt crystallizer and a blower that is required overcome gas flow pressure drop. The electricity could also power a conveyer, vibrating screen, and the necessary pumps. In this process option, a separate natural gas furnace to supply additional heat requirements may be required. The determination of the utility of an integrated gas turbine is dependent upon local factors including cost of electricity and the plant's ability to repurpose surplus electricity generated to other uses.

### 1.6 Hydrochloric Acid Collection

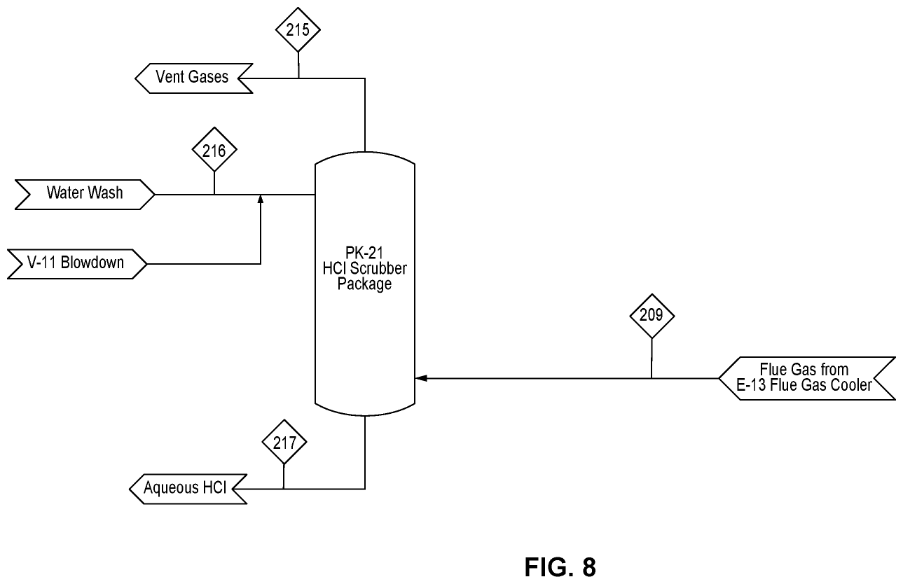

The hot flue gas from the furnace pyrolyzes the magnesium-rich mixed salt through direct contact in a rotary kiln reactor serving as the bittern pyrolysis chamber. The supplied flue gas will preferably have a vol % composition of 76-80% N₂, 12-16% O₂, 5-8% H₂O, and 2-4% CO₂ and will acquire a 90% yield of HCl and a 10% yield of H₂O from the pyrolysis step within the pyrolysis chamber. The process flue gas from the bittern pyrolysis chamber (rotary kiln reactor) may then be directed to an HCl scrubber (see FIG. 8) where it is cooled to 35° C. so as to condense a concentrated HCl solution product preferably >30 wt %. The cooling water supplied to the scrubber can be from any available salt, e.g., saltwater from a solar evaporation pond.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

### LIST OF REFERENCE CITATIONS¹

¹ The entire content of each cited reference is expressly incorporated hereinto by reference.
(1) Wheeler, A. F., Final Feasibility and Cost Analysis Findings and Recommendations Report—Paradox Valley Unit Byproducts Disposal Study. (2017).
(2) Kaushik Patowary. Monte Kali: A Mountain of Table Salt. Amusing Planet (2016).
(3) Steinhauser, G. Cleaner production in the Solvay Process: general strategies and recent developments Cleaner production in the Solvay Process: general strategies and recent developments. J. Clean. Prod. 16, 833-841 (2018).
(4) Sherry, D. Product Profile: Calcium chloride. Indep. Comodity Intell. Services (2005).
(5) Leahy, S. Hidden Costs of Climate Change Running Hundreds of Billions a Year. Natl. Geogr. Mag. (2017).
(6) Scheme, E. U. E. T. The European Chlor-Alkali industry: an electricity intensive sector exposed to carbon leakage. Brussels Euro Chlor. Available online http//www. eurochlororg/media/9385/3-2-the_european_chloralkali_industry_-_an_electricity_intensive_sector_exposed_to_carbon_leakage.pdf (accessed May 10, 2019) (2010).
(7) Marianne Wesnms, B. W. Long-term market reactions to changes in demand for NaOH. https://lca-netcom (2006).
(8) Butts D et al Sodium Sulfates and Sulfides. in Kirk-Othmer Encyclopedia of Chemical Technology (John Wiley & Sons, Inc, 2013).
(9) Baseggio, G. The Composition of Sea Water and Its Concentrates. Fourth International Symposium on Salts, Vol. 2 (1974).
(10) Huang, Q., Lu, G., Wang, J. & Yu, J. Thermal decomposition mechanisms of MgCl2·6H2O and MgCl2·H2O. J. Anal. Appl. Pyrolysis 91, 159-164 (2011).
(11) Mgcl, O., Huang, Q., Lu, G., Wang, J. I. N. & Yu, J. Mechanism and Kinetics of Thermal Decomposition. 41, (2010).
(12) Huang, Q., Lu, G., Wang, J. & Yu, J. Journal of Analytical and Applied Pyrolysis Thermal decomposition mechanisms of MgCl2·6H2O and MgCl2·H2O. 91, 159-164 (2011).
(13) Ng, K. & Harris, R. MgOHCl Thermal Decomposition Kinetics. 36, 153-157 (2005).
(14) Altmaier, M.; Metz, V.; Neck, V.; Müller, R.; Fanghänel, T. Solid-liquid equilibria of Mg(OH)2(cr) and Mg2(OH)3Cl·4H2O(cr) in the system Mg—Na—H—OH—Cl—H2O at 25° C. Geochim. Cosmochim. Acta 67, 3595-3601 (2003).
(15) Sanna, A.; Uibu, M.; Caramanna, G.; Kuusik, R.; Maroto-Valer, M. M. A review of mineral carbonation technologies to sequester CO2. Chem. Soc. Rev. 43, 8049-8080 (2014).
(16) Bowen, B. OUTLOOK '19: US HCl market expects stronger demand, firming prices. Independent Commodity Intelligence Services (2019).
(17) Garside, M. Chlorine Production in the United States from 1990-2018. Statistica (2019).
(18) Hydrometallurgy, C. et al. New Technologies for HCl Regeneration in New Technologies for HCl Regeneration in Chloride Hydrometallurgy. (2008).
(19) Napp, C. K. Trends and Views in the Development of Technologies for Chlorine Production from. 1-10 (2010).
(20) Bolen, B. W. P. 2015 Minerals Yearbook: Salt. (2017).
(21) Kostick, B. D. S. Sdium Sulfate. USGS Miner. Commod. Summ. (1997).
(22) Christensen, J. Primer: Section 45Q Tax Credit for Carbon Capture Projects. Carbon Management (2019).
(23) Ets, E. U. et al. The European Chlor-Alkali industry: an electricity intensive sector exposed to carbon leakage. 2-6 (2010).
(24) Determination of Mg by Titration with EDTA. Truman State Univ. CHEM 222 Lab Man. (2008).
(25) Gustafsson, J. Visual MINTEQ ver. 3.1. KTH Dep. L. Water Resour. Eng. Stock. Sweden. https://vm, (2012).
(26) Bolen, W. P. Salt. US Geol. Surv. Miner. Commod. Summ. (2016).
(27) M. Garside. Chlorine production in the United States from 1990 to 2018. Statistica (2019).
(28) Wallace P. Bolen. SODA ASH. U.S. Geol. Surv. Miner. Commod. Summ. (2019).
(29) M. Garside. Caustic soda production in the United States from 1990 to 2018. Statistica (2019).
(30) Dennis S. Kostick. Sodium Sulfate. U.S. Geol. Surv. Miner. Commod. Summ. (2013).

What is claimed is:

1. A process to pyrolytically extract hydrochloric acid from a magnesium ion-rich salt or salt mixture, the process comprising the steps of:
(a) directing a supply of the magnesium ion-rich salt or salt mixture to a pyrolytic chamber;
(b) contacting the salt or salt mixture in a pyrolytic chamber with heated gas at a sufficient temperature and for a sufficient time to form a vapor product stream comprised of hydrochloric acid and solid pyrolyzed mixed salt stream comprised of magnesium hydroxide optionally with other potential salts selected from the group consisting of sodium chloride, sodium sulfate and potassium chloride;
(c) separating the solid pyrolyzed mixed salt stream into separate product streams comprising the insoluble magnesium hydroxide optionally with any soluble salt components selected from the group consisting of sodium chloride, sodium sulfate and potassium chloride;
(d) condensing the vapor product stream of hydrochloric acid from the pyrolytic chamber to form an aqueous HCl solution.

2. The process according to claim 1, wherein step (a) comprises dehydrating the salt mixture so as to provide the salt mixture with magnesium ions in tetrahydrate or lower state.

3. The process according to claim 2, wherein step (a) comprises dehydrating the salt mixture so as to provide the salt mixture with magnesium ions in monohydrate to trihydrate state.

4. The process according to claim 2, wherein step (a) comprises:
(a1) initially dehydrating the salt mixture so as to provide the salt mixture with magnesium ions in a tetrahydrate state, and thereafter
(a2) further dehydrating the salt mixture so as to convert the magnesium ions in a tetrandrate state therein to achieve a salt mixture with magnesium ions in monohydrate to trihydrate state.

5. The process according to claim 1, wherein step (b) wherein the heated gas is heated combustion gas obtained by combusting a fossil fuel.

6. The process according to claim 5, wherein the fossil fuel is natural gas.

7. The process according to claim 5, wherein the combustion gas is at a temperature of about 300° C. to about 900° C. and contacts the salt mixture for a time between about 5 to about 80 minutes.

8. The process according to claim 5, wherein the combustion gas is stochiometrically lean.

9. The process according to claim 1, wherein step (c) comprises washing the solid pyrolyzed mixed salt stream in seawater to wash any of the soluble salt components from the insoluble magnesium hydroxide.

10. The process according to claim 9, which comprises precipitating sodium sulfate decahydrate from the wash of the soluble salt components at a yield of greater than 80 mol %.

11. The process according to claim 10, wherein the sodium sulfate decahydrate is dried and filtered to form an anhydrous sodium sulfate product.

12. The process according to claim 9, wherein the washing step comprises separating the sodium sulfate decahydrate solids from a mixed sodium chloride and potassium chloride solution.

13. The process according to claim 12, further comprising evaporating the mixed sodium chloride and potassium chloride solution to obtain a mixed product stream comprised of solid particulate sodium chloride and potassium chloride.

14. The process according to claim 9, wherein the insoluble magnesium is prepared as a magnesium oxide or hydroxide product.

15. The process according to claim 9, wherein the insoluble magnesium is converted to magnesium carbona through absorption of carbon dioxide.

16. The process according to claim 9, wherein the insoluble magnesium is recycled to magnesium chloride using ammonium chloride.
